(19) United States
(12) Patent Application Publication
(10) Pub. No.: US 2020/0195038 A1
(43) Pub. Date: Jun. 18, 2020

(54) MOTION ENERGY HARVESTING CIRCUIT AND PORTABLE ELECTRONIC DEVICE

(71) Applicant: BYD COMPANY LIMITED, Shenzhen, Guangdong (CN)

(72) Inventors: Yun JIANG, Shenzhen (CN); Qing RONG, Shenzhen (CN); Conghua JIANG, Shenzhen (CN); Hu ZHOU, Shenzhen (CN)

(73) Assignee: BYD COMPANY LIMITED, Shenzhen, Guangdong (CN)

(21) Appl. No.: 16/349,573

(22) PCT Filed: Nov. 10, 2017
(86) PCT No.: PCT/CN2017/110480

§ 371 Date: May 13, 2019

(30) Foreign Application Priority Data
Nov. 23, 2016 (CN) 201611059105.X

(51) Int. Cl. H02J 7/32; H02J 7/00

(52) U.S. Cl. CPC H02J 7/32; H02J 7/0019; H02J 7/0044

(57) ABSTRACT

A circuit includes: a power generation module a low-frequency motion energy harvesting module, configured to harvest a direct current output by the power generation module when the human body is in a low-frequency motion state; a high-frequency motion energy harvesting module, configured to harvest a direct current output by the power generation module when the human body is in a high-frequency motion state; an energyrespectively connected to the low frequency motion cncrgy harvesting modulo configured to store electrical energy; and a motion switching module, respectively connected to the power generation module, the low-frequency motion energy harvesting module and the high-frequency motion energy harvesting module, and configured to monitor a human body motion state, and control, according to the human body motion state, switching between operation of the low-frequency motion energy harvesting module and operation of the high-frequency motion energy harvesting module, to respectively charge the energy storage module.

### CROSS-REFERENCE TO RELATED APPLICATIONS

This application is the U.S. national phase entry of PCT Application No. PCT/CN2017/110480, filed Nov. 10, 2017, which is based on and claims priority to Chinese Patent Application No. 201611059105.X, filed on Nov. 23, 2016, which are incorporated herein by reference in their entireties.

### FIELD

The present invention relates to the technical field of electronic devices, and in particular, to a motion energy harvesting circuit and a portable electronic device.

### BACKGROUND

Today, wearable smart electronic devices are increasingly favored by consumers, but the problem of battery life has always restricted the development of the entire wearable smart electronic device industry. At present, popular wearable smart devices on the market basically adopt a built-in lithium battery, but generally have a short battery life.

No matter for smart watches, smart phones, or other types of electronic products, battery life is the biggest obstacle to their development. To maximize the battery life, most wearable smart devices have taken the practice of sacrificing configuration and functionality, thereby greatly lowering user experience.

### SUMMARY

An objective of the present invention is to at least resolve one of the technical problems in the related art to some extent. Accordingly, a first objective of the present invention is to provide a motion energy harvesting circuit that can avoid a waste of motion energy and improve the harvesting efficiency of motion energy.

A second objective of the present invention is to provide a portable electronic device.

To achieve the above objectives, an embodiment of the first aspect of the present invention provides a motion energy harvesting circuit, including: a power generation module, where the power generation module is configured to convert kinetic energy generated by human body motion into electrical energy and output a direct current; a low-frequency motion energy harvesting module, where the low-frequency motion energy harvesting module is configured to harvest a direct current output by the power generation module when the human body is in a low-frequency motion state; a high-frequency motion energy harvesting module, where the high-frequency motion energy harvesting module is configured to harvest a direct current output by the power generation module when the human body is in a high-frequency motion state; an energy storage module, where the energy storage module is respectively connected to the low-frequency motion energy harvesting module and the high-frequency motion energy harvesting module and configured to store electrical energy; and a motion switching module, where the motion switching module is respectively connected to the power generation module, the low-frequency motion energy harvesting module and the high-frequency motion energy harvesting module, and the motion switching module is configured to monitor a human body motion state, and controlling the switching between operation of the low-frequency motion energy harvesting module and operation of the high-frequency motion energy harvesting module according to the human body motion state, to respectively charge the energy storage module.

According to the motion energy harvesting circuit of the embodiments of the present invention, the power generation module converts kinetic energy generated by human body motion into electrical energy and output a direct current, and the motion switching module monitors a human body motion state, so as to according to the human body motion state, control the low-frequency motion energy harvesting module to harvest the direct current output by the power generation module when the human body is in a low-frequency motion state and control the high-frequency motion energy harvesting module to harvest the direct current output by the power generation module when the human body is in a high-frequency motion state, so as to respectively charge the energy storage module. The circuit can avoid a waste of motion energy and improve the harvesting efficiency of motion energy.

To achieve the above objectives, an embodiment of the second aspect of the present invention provides a portable electronic device, including the above-mentioned motion energy harvesting circuit.

By means of the above-mentioned motion energy harvesting circuit, the portable electronic device according to the embodiments of the present invention can avoid a waste of motion energy and improve the harvesting efficiency of motion energy.

### BRIEF DESCRIPTION OF THE DRAWINGS

FIG. 1 is a block schematic diagram of a motion energy harvesting circuit according to embodiments of the present invention;

FIG. 2 is a block schematic diagram of a motion switching module according to one embodiment of the present invention;

FIG. 3 is a structural schematic diagram of a motion energy harvesting circuit according to one embodiment of the present invention;

FIG. 4 is a structural schematic diagram of a motion energy harvesting circuit according to another embodiment of the present invention;

FIG. 5 is a structural schematic diagram of a motion energy harvesting circuit according to still another embodiment of the present invention; and

FIG. 6 is a block schematic diagram of a portable electronic device according to embodiments of the present invention.

### DETAILED DESCRIPTION

The following describes in detail embodiments of the present invention. Examples of the embodiments are shown in the accompanying drawings, where reference signs that are the same or similar from beginning to end represent same or similar components or components that have same or similar functions. The following embodiments described with reference to the accompanying drawings are exemplary, and are intended to describe the present invention and cannot be construed as a limitation to the present invention.

The motion energy harvesting circuit and the portable electronic device of the embodiments of the present invention will be described below with reference to the accompanying drawings.

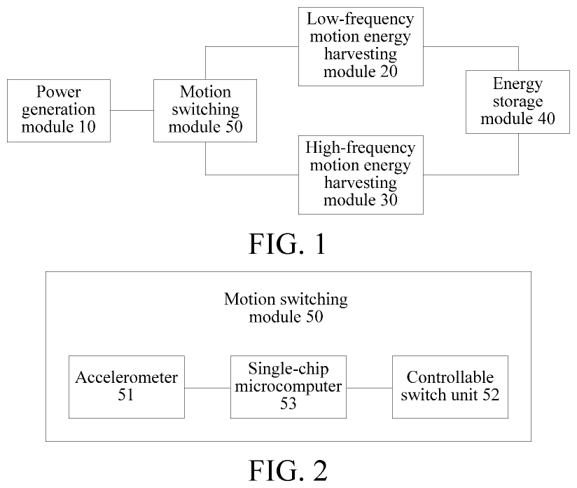

FIG. 1 is a block schematic diagram of a motion energy harvesting circuit according to embodiments of the present invention. As shown in FIG. 1, the motion energy harvesting circuit of the embodiments of the present invention includes: a power generation module 10, a low-frequency motion energy harvesting module 20, a high-frequency motion energy harvesting module 30, an energy storage module 40, and a motion switching module 50.

The power generation module 10 is configured to convert kinetic energy generated by human body motion into electrical energy and output a direct current. The low-frequency motion energy harvesting module 20 is configured to harvest a direct current output by the power generation module 10 when the human body is in a low-frequency motion state. The high-frequency motion energy harvesting module 30 is configured to harvest a direct current output by the power generation module 10 when the human body is in a high-frequency motion state. The energy storage module 40 is respectively connected to the low-frequency motion energy harvesting module 20 and the high-frequency motion energy harvesting module 30 and configured to store electrical energy. The motion switching module 50 is respectively connected to the power generation module 10, the low-frequency motion energy harvesting module 20 and the high-frequency motion energy harvesting module 30. The motion switching module 50 is configured to monitor a human body motion state, and control, according to the human body motion state, switching between operation of the low-frequency motion energy harvesting module 20 and operation of the high-frequency motion energy harvesting module 30, to respectively charge the energy storage module 40.

It can be understood that the low-frequency motion means that the human body is in a low-frequency motion state, for example, walking and unconscious hand raising. The high-frequency motion means that the human body is in a high-frequency motion state, for example, running and other strenuous motions. The power generation module 10 can convert the kinetic energy generated when the human body is in a low-frequency motion state or a high-frequency motion state into electrical energy, and output a direct current.

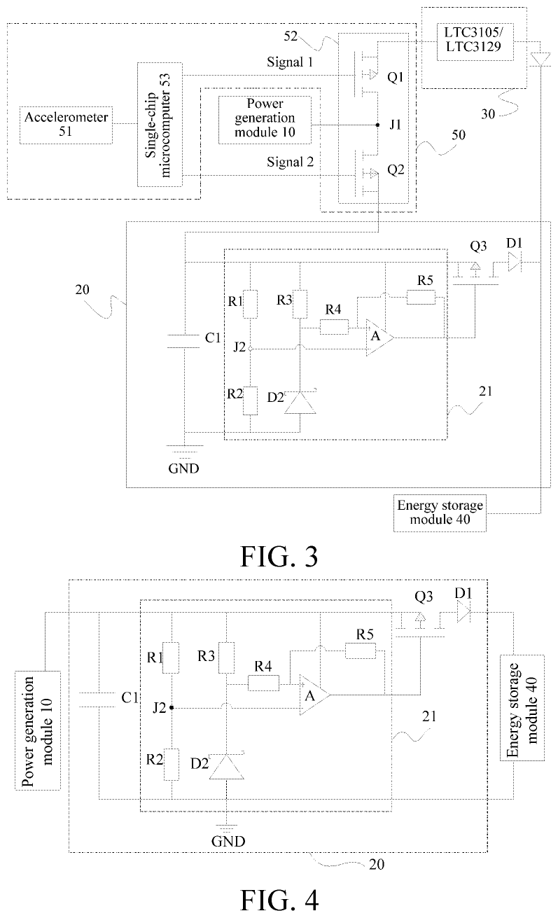

In one embodiment of the present invention, as shown in FIG. 2, the motion switching module 50 includes an accelerometer 51, a controllable switch unit 52, and a single-chip microcomputer 53. The accelerometer 51 is configured to detect human body acceleration information. As shown in FIG. 3, a first end of the controllable switch unit 52 is connected to the power generation module 10, a second end of the controllable switch unit 52 is connected to the low-frequency motion energy harvesting module 20, and a third end of the controllable switch unit 52 is connected to the high-frequency motion energy harvesting module 30. The single-chip microcomputer 53 is respectively connected to the accelerometer 51 and a control end of the controllable switch unit 52. The single-chip microcomputer 53 is configured to determine the human body motion state according to the human body acceleration information, and to control the controllable switch unit 52 when the human body is in the low-frequency motion state such that the low-frequency motion energy harvesting module 20 harvests the direct current output by the power generation module 10 and intermittently charges the energy storage module 40, and control the controllable switch unit 52 when the human body is in the high-frequency motion state such that the high-frequency motion energy harvesting module 30 harvests the direct current output by the power generation module 10 and continuously charges the energy storage module 40.

In one embodiment of the present invention, as shown in FIG. 3, the controllable switch unit 52 includes a first MOSFET Q1 and a second MOSFET Q2. A gate of the first MOSFET Q1 is connected to a first output end of the single-chip microcomputer 53, and a source of the first MOSFET Q1 serves as the third end of the controllable switch unit 52. A gate of the second MOSFET Q2 is connected to a second output end of the single-chip microcomputer 53, a source of the second MOSFET Q2 serves as the second end of the controllable switch unit 52, a drain of the first MOSFET Q1 is connected to a drain of the second MOSFET Q2, a first node J1 is provided between the drain of the first MOSFET Q1 and the drain of the second MOSFET Q2, and the first node J1 serves as the first end of the controllable switch unit 52.

Specifically, the accelerometer 51 can be used to detect the human body acceleration information, and the single-chip microcomputer 53 can be used to determine whether the human body motion state is the low-frequency motion state or the high-frequency motion state according to the human body acceleration information.

Specifically, as shown in FIG. 3, if it is detected that the human body is in a low-frequency motion state, the single-chip microcomputer 53 outputs a signal 1 as a low level signal and a signal 2 as a high level signal, thereby controlling the first MOSFET Q1 to be in an off state and the second MOSFET Q2 to be in an on state. At this time, by controlling the controllable switch unit 52, the low-frequency motion energy harvesting module 20 harvests the direct current output by the power generation module 10 and intermittently charges the energy storage module 40. The energy storage module 40 may be a supercapacitor or a rechargeable battery.

In one embodiment of the present invention, as shown in FIG. 4, when the low-frequency motion energy harvesting module 20 is used to harvest the direct current output by the power generation module 10 and intermittently charge the energy storage module 40, an operating portion of the motion energy harvesting circuit includes the power generation module 10, the low-frequency motion energy harvesting module 20 and the energy storage module 40. The low-frequency motion energy harvesting module 20 includes a first capacitor Cl, a third MOSFET Q3, a first diode D1 and a driving unit 21. A first end of the first capacitor C1 is connected to the second end of the controllable switch unit 52, and a second end of the first capacitor C1 is connected to the ground GND. A source of the third MOSFET Q3 is connected to one end of the first capacitor C1. An anode of the first diode D1 is connected to a drain of the third MOSFET Q3, and a cathode of the first diode D1 is connected to the energy storage module 40. An output end of the driving unit 21 is connected to a gate of the third MOSFET Q3, and the driving unit 21 intermittently drives the third MOSFET Q3 to be turned on and off according to a voltage on the two ends of the first capacitor C1 such that the low-frequency motion energy harvesting module 20 intermittently charges the energy storage module 40.

Further, as shown in FIG. 4, the driving unit 21 includes: a first resistor R1, a second resistor R2, a third resistor R3, a second diode D2, a fourth resistor R4, an amplifier A, and a fifth resistor R5. The first resistor R1 is connected in series with the second resistor R2 and connected in parallel with the first capacitor C1, and a second node J2 is provided between the first resistor R1 and the second resistor R2. One end of the third resistor R3 is connected to the first end of the first capacitor C1. A cathode of the second diode D2 is connected to the other end of the third resistor R3, and an anode of the second diode D2 is connected to the second end of the first capacitor C1. One end of the fourth resistor R4 is respectively connected to the other end of the third resistor R3 and the cathode of the second diode D2. A positive input end of the amplifier A is connected to the other end of the fourth resistor R4, a negative input end of the amplifier A is connected to the second node J2, and an output end of the amplifier A is connected to the gate of the third MOSFET Q3. The fifth resistor R5 is connected between the positive input end of the amplifier A and the output end of the amplifier. The second diode D2 may be a Schottky diode.

Specifically, when the human body is in the low-frequency motion state, the power generation module 10 converts the kinetic energy generated by the human body motion into electrical energy. When the electrical energy causes the voltage across the two ends of the first capacitor C1 to reach a certain threshold, for example, 3V, the driving unit 21 drives the third MOSFET Q3 to be turned on, the voltage of the first capacitor C1 charges the energy storage module 40 through the first diode D1. And at this time, the voltage across the two ends of the first capacitor C1 is decreased. When the voltage across the two ends of the first capacitor C1 is decreased to a second threshold, for example, 1V, the driving unit 21 drives the third MOSFET Q3 to be turned off. When the electrical energy causes the voltage across the two ends of the first capacitor C1 to reach 3V again, the driving unit 21 drives the third MOSFET Q3 to be turned on again, and the first capacitor C1 charges the energy storage module 40 again. Thus, the driving unit 21 is used to intermittently drive the third MOSFET Q3 to be turned on and off according to the voltage across the two ends of the first capacitor C1 such that the low-frequency motion energy harvesting module 20 harvests the direct current output by the power generation module 10 and intermittently charges the energy storage module 40. The first threshold and the second threshold may be set as needed, and may be implemented by adjusting the resistances of the resistors R1-R5.

Specifically, as shown in FIG. 3, if it is detected that the human body is in a high-frequency motion state, the single-chip microcomputer 53 outputs a signal 1 as a high level signal and a signal 2 as a low level signal, thereby controlling the first MOSFET Q1 to be in an on state and the second MOSFET Q2 to be in an off state. At this time, by controlling the controllable switch unit 52, the high-frequency motion energy harvesting module 30 harvests the direct current output by the power generation module 10 and continuously charges the energy storage module 40.

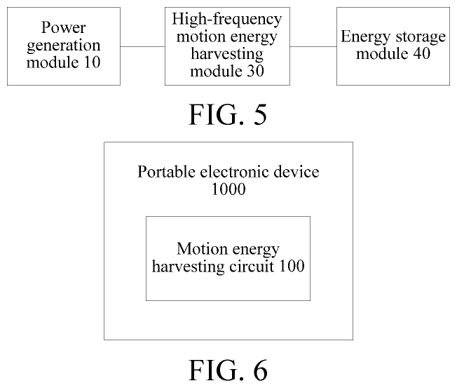

In one embodiment of the present invention, as shown in FIG. 5, when the high-frequency motion energy harvesting module 30 is used to harvest the direct current output by the power generation module 10 and continuously charge the energy storage module 40, the operating portion of the motion energy harvesting circuit may include the power generation module 10, the high-frequency motion energy harvesting module 30 and the energy storage module 40. The high-frequency motion energy harvesting module 30 may be implemented by using an LTC3105 or LTC3129 boost energy harvesting chip to charge the energy storage module 40 by means of continuous output.

Specifically, when the human body is in a high-frequency motion state, the power generation module 10 converts the kinetic energy generated by the human body motion into electrical energy, and the generated electrical energy is harvested by the LTC3105 or LTC3129 boost energy harvesting chip in the form of direct current to continuously charge the energy storage module 40.

It should be understood that the kinetic energy generated when the human body is in the low-frequency motion state is small, and therefore the voltage of the direct current output by the power generation module 10 is lower; and the kinetic energy generated when the human body is in the high-frequency motion state is large, and therefore the voltage of the direct current output by the power generation module 10 is higher. Since the motion switching module 50 monitors the human body motion state and controls, according to the human body motion state, switching between operation of the low-frequency motion energy harvesting module 20 and operation of the high-frequency motion energy harvesting module 30, the motion energy harvesting circuit according to the embodiments of the present invention can separately harvest motion energies of different magnitudes and corresponding to different motion states, thereby avoiding a waste of motion energy and improving the harvesting efficiency of motion energy.

Further, the energy storage module 40 controls the supply current of the stored electrical energy to flow to the load through the diode, so as to provide electrical energy for the load. The motion energy harvesting circuit of the embodiments of the present invention can be used not only in the wearable smart electronic devices, but also in an industrial occasion with certain motion energy generation, for example, an Internet of Things node and a smart home.

In summary, according to the motion energy harvesting circuit of the embodiments of the present invention, the power generation module converts kinetic energy generated by human body motion into electrical energy and outputs a direct current, and the motion switching module monitors a human body motion state, so as to according to the human body motion state, control the low-frequency motion energy harvesting module to harvest the direct current output by the power generation module when the human body is in a low-frequency motion state and control the high-frequency motion energy harvesting module to harvest the direct current output by the power generation module when the human body is in a high-frequency motion state, and respectively charge the energy storage module. The circuit can avoid a waste of motion energy and improve the harvesting efficiency of motion energy, and is energy-saving and environmentally-friendly.

Based on the above embodiments, the present invention further provides a portable electronic device.

FIG. 6 shows a portable electronic device according to embodiments of the present invention. As shown in FIG. 6, the portable electronic device 1000 includes the motion energy harvesting circuit 100 of the above embodiments.

Specifically, the portable electronic device 1000 may be a wearable electronic device. The wearable electronic device may include a smart band or a smart watch.

It should be noted that, for details not disclosed in the portable electronic device 1000 of the embodiments of the present invention, please refer to the details disclosed in the motion energy harvesting circuit 100 of the embodiments of the present invention, which will not be described in detail herein.

The portable electronic device of the embodiments of the present invention can avoid a waste of motion energy and improve the harvesting efficiency of motion energy by means of the above-mentioned motion energy harvesting circuit, and is energy-saving and environmentally-friendly.

In the description of the present invention, it should be understood that, orientations or position relationships indicated by terms such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial”, and “circumferential” are orientations or position relationship shown based on the accompanying drawings, and are merely used for describing the present invention and simplifying the description, rather than indicating or implying that the apparatus or element should have a particular orientation or be constructed and operated in a particular orientation, and therefore, should not be construed as a limitation on the present invention.

In addition, terms “first” and “second” are used only for description purposes, and shall not be understood as indicating or suggesting relative importance or implicitly indicating a quantity of indicated technical features. Therefore, features defined by “first” and “second” may explicitly or implicitly include at least one feature. In the description of the present invention, unless otherwise specifically limited, “multiple” means at least two, for example, two or three.

In the present invention, it should be noted that unless otherwise clearly specified and limited, the terms “mounted”, “connected”, “connection”, and “fixed” should be understood in a broad sense. For example, a connection may be a fixed connection, a detachable connection, or an integral connection; may be a mechanical connection or an electrical connection; may be a direct connection or an indirect connection by means of an intermediate medium; or may be internal communication between two elements or interaction relationship between two elements, unless otherwise clearly limited. A person of ordinary skill in the art may understand specific meanings of the terms in the present invention according to specific situations.

In the present invention, unless otherwise clearly specified and limited, that a first feature is “above” or “below” a second feature may be that the first and the second features are in contact with each other directly, or the first and the second features are in contact with each other indirectly by using an intermediate medium. Moreover, that the first feature is “above”, “over”, and “on” the second feature may be that the first feature is right above the second feature or at an inclined top of the second feature, or may merely indicate that the horizontal height of the first feature is higher than that of the second feature. That the first feature is “below”, “under”, and “beneath” the second feature may be that the first feature is right below the second feature or at an inclined bottom of the second feature, or may merely indicate that the horizontal height of the first feature is lower than that of the second feature.

In the description of the specification, the description made with reference to terms such as “one embodiment”, “some embodiments”, “example”, “specific example”, or “some examples” means that a specific characteristic, structure, material or feature described with reference to the embodiment or example is included in at least one embodiment or example of the present invention. In this specification, schematic descriptions of the foregoing terms do not need to aim at a same embodiment or example. Besides, the specific features, the structures, the materials or the characteristics that are described may be combined in a proper manner in any one or more embodiments or examples. In addition, in a case that is not mutually contradictory, persons skilled in the art can combine or group different embodiments or examples that are described in this specification and features of the different embodiments or examples.

Although the embodiments of the present invention are shown and described above, it can be understood that, the foregoing embodiments are exemplary, and cannot be construed as a limitation to the present invention. Within the scope of the present invention, a person of ordinary skill in the art may make changes, modifications, replacement, and variations to the foregoing embodiments.

What is claimed is:

1. A motion energy harvesting circuit, comprising:
a power generation module, wherein the power generation module is configured to convert kinetic energy generated by human body motion into electrical energy and output a direct current;
a low-frequency motion energy harvesting module, wherein the low-frequency motion energy harvesting module is configured to harvest a direct current output by the power generation module when the human body is in a low-frequency motion state;
a high-frequency motion energy harvesting module, wherein the high-frequency motion energy harvesting module is configured to harvest a direct current output by the power generation module when the human body is in a high-frequency motion state;
an energy storage module, wherein the energy storage module is respectively connected to the low-frequency motion energy harvesting module and the high-frequency motion energy harvesting module and configured to store electrical energy; and
a motion switching module, wherein the motion switching module is respectively connected to the power generation module, the low-frequency motion energy harvesting module and the high-frequency motion energy harvesting module, and the motion switching module is configured to monitor a human body motion state, and controlling the switching between an operation of the low-frequency motion energy harvesting module and an operation of the high-frequency motion energy harvesting module according to the human body motion state, to respectively charge the energy storage module.

2. The motion energy harvesting circuit according to claim 1, wherein the motion switching module comprises:
an accelerometer, wherein the accelerometer is configured to detect human body acceleration information;
a controllable switch unit, wherein a first end of the controllable switch unit is connected to the power generation module, a second end of the controllable switch unit is connected to the low-frequency motion energy harvesting module, and a third end of the controllable switch unit is connected to the high-frequency motion energy harvesting module; and
a single-chip microcomputer, wherein the single-chip microcomputer is respectively connected to the accelerometer and a control end of the controllable switch unit, and the single-chip microcomputer is configured to determine the human body motion state according to the human body acceleration information, and to control the controllable switch unit when the human body is in the low-frequency motion state such that the low-frequency motion energy harvesting module harvests the direct current output by the power generation module and intermittently charges the energy storage module, and to control the controllable switch unit when the human body is in the high-frequency motion state such that the high-frequency motion energy harvesting module harvests the direct current output by the power generation module and continuously charges the energy storage module.

3. The motion energy harvesting circuit according to claim 2, wherein the controllable switch unit comprises:
a first MOSFET, wherein a gate of the first MOSFET is connected to a first output end of the single-chip microcomputer, and a source of the first MOSFET serves as the third end of the controllable switch unit; and
a second MOSFET, wherein a gate of the second MOSFET is connected to a second output end of the single-chip microcomputer, a source of the second MOSFET serves as the second end of the controllable switch unit, a drain of the first MOSFET is connected to a drain of the second MOSFET, a first node is provided between the drain of the first MOSFET and the drain of the second MOSFET, and the first node serves as the first end of the controllable switch unit.

4. The motion energy harvesting circuit according to claim 2, wherein the low-frequency motion energy harvesting module comprises:
a first capacitor, wherein a first end of the first capacitor is connected to the second end of the controllable switch unit, and a second end of the first capacitor is connected to the ground;
a third MOSFET, wherein a source of the third MOSFET is connected to the first end of the first capacitor;
a first diode, wherein an anode of the first diode is connected to a drain of the third MOSFET, and a cathode of the first diode is connected to the energy storage module; and
a driving unit, wherein an output end of the driving unit is connected to a gate of the third MOSFET, and the driving unit is configured to intermittently drive the third MOSFET to be turned on and off, according to a voltage on the two ends of the first capacitor such that the low-frequency motion energy harvesting module intermittently charges the energy storage module.

5. The motion energy harvesting circuit according to claim 4, wherein the driving unit comprises:
a first resistor and a second resistor, wherein the first resistor is connected in series with the second resistor and connected in parallel with the first capacitor, and a second node is provided between the first resistor and the second resistor;
a third resistor, wherein one end of the third resistor is connected to one end of the first capacitor;
a second diode, wherein a cathode of the second diode is connected to the other end of the third resistor, and an anode of the second diode is connected to the other end of the first capacitor;
a fourth resistor, wherein one end of the fourth resistor is respectively connected to the other end of the third resistor and the cathode of the second diode;
an amplifier, wherein a positive input end of the amplifier is connected to the other end of the fourth resistor, a negative input end of the amplifier is connected to the second node, and an output end of the amplifier is connected to the gate of the third MOSFET; and
a fifth resistor, wherein the fifth resistor is connected between the positive input end of the amplifier and the output end of the amplifier.

6. The motion energy harvesting circuit according to claim 1, wherein the high-frequency motion energy harvesting module is implemented by using an LTC3105 or LTC3129 boost energy harvesting chip and configured to continuously charge the energy storage module during operation.

7. The motion energy harvesting circuit according to claim 1, wherein the energy storage module is a supercapacitor or a rechargeable battery.

8. A portable electronic device, comprising the motion energy harvesting circuit according to claim 1.

9. The portable electronic device according to claim 8, wherein the portable electronic device is a wearable electronic device.

10. The portable electronic device according to claim 9, wherein the wearable electronic device comprises a smart band or a smart watch.

11. The motion energy harvesting circuit according to claim 3, wherein the low-frequency motion energy harvesting module comprises:
a first capacitor, wherein a first end of the first capacitor is connected to the second end of the controllable switch unit, and a second end of the first capacitor is connected to the ground;
a third MOSFET, wherein a source of the third MOSFET is connected to the first end of the first capacitor;
a first diode, wherein an anode of the first diode is connected to a drain of the third MOSFET, and a cathode of the first diode is connected to the energy storage module; and
a driving unit, wherein an output end of the driving unit is connected to a gate of the third MOSFET, and the driving unit is configured to intermittently drive the third MOSFET to be turned on and off, according to a voltage on the two ends of the first capacitor such that the low-frequency motion energy harvesting module intermittently charges the energy storage module.

12. The motion energy harvesting circuit according to claim 11, wherein the driving unit comprises:
a first resistor and a second resistor, wherein the first resistor is connected in series with the second resistor and connected in parallel with the first capacitor, and a second node is provided between the first resistor and the second resistor;
a third resistor, wherein one end of the third resistor is connected to one end of the first capacitor;
a second diode, wherein a cathode of the second diode is connected to the other end of the third resistor, and an anode of the second diode is connected to the other end of the first capacitor;
a fourth resistor, wherein one end of the fourth resistor is respectively connected to the other end of the third resistor and the cathode of the second diode;
an amplifier, wherein a positive input end of the amplifier is connected to the other end of the fourth resistor, a negative input end of the amplifier is connected to the second node, and an output end of the amplifier is connected to the gate of the third MOSFET; and
a fifth resistor, wherein the fifth resistor is connected between the positive input end of the amplifier and the output end of the amplifier.

13. The motion energy harvesting circuit according to claim 2, wherein the high-frequency motion energy harvesting module is implemented by using an LTC3105 or LTC3129 boost energy harvesting chip and configured to continuously charge the energy storage module during operation.

14. The motion energy harvesting circuit according to claim 3, wherein the high-frequency motion energy harvesting module is implemented by using an LTC3105 or LTC3129 boost energy harvesting chip and configured to continuously charge the energy storage module during operation.

15. The motion energy harvesting circuit according to claim 4, wherein the high-frequency motion energy harvesting module is implemented by using an LTC3105 or LTC3129 boost energy harvesting chip and configured to continuously charge the energy storage module during operation.

16. The motion energy harvesting circuit according to claim 5, wherein the high-frequency motion energy harvesting module is implemented by using an LTC3105 or LTC3129 boost energy harvesting chip and configured to continuously charge the energy storage module during operation.

17. The motion energy harvesting circuit according to claim 11, wherein the high-frequency motion energy harvesting module is implemented by using an LTC3105 or LTC3129 boost energy harvesting chip and configured to continuously charge the energy storage module during operation.

18. The motion energy harvesting circuit according to claim 12, wherein the high-frequency motion energy harvesting module is implemented by using an LTC3105 or LTC3129 boost energy harvesting chip and configured to continuously charge the energy storage module during operation.

19. The motion energy harvesting circuit according to claim 16, wherein the energy storage module is a supercapacitor or a rechargeable battery.

20. The motion energy harvesting circuit according to claim 18, wherein the energy storage module is a supercapacitor or a rechargeable battery.
